(19) United States
(12) Patent Application Publication
(10) Pub. No.: US 2024/0063483 A1
(43) Pub. Date: Feb. 22, 2024

(54) SECONDARY BATTERY

(71) Applicant: MURATA MANUFACTURING CO., LTD., Kyoto (JP)

(72) Inventor: Kenta HONDA, Kyoto (JP)

(21) Appl. No.: 18/386,493

(22) Filed: Nov. 2, 2023

Related U.S. Application Data
(63) Continuation of application No. PCT/JP2022/007294, filed on Feb. 22, 2022.

(30) Foreign Application Priority Data
Jun. 30, 2021 (JP) 2021-109640

(51) Int. Cl. H01M 50/181; H01M 50/107; H01M 50/153; H01M 50/533; H01M 50/119

(52) U.S. Cl. CPC H01M 50/181; H01M 50/107; H01M 50/153; H01M 50/533; H01M 50/119

(57) ABSTRACT

A secondary battery includes an outer package member, a battery device, an external terminal, and a coupling wiring line. The battery device is placed in the outer package member and includes a first electrode and a second electrode. The external terminal is attached to the outer package member and electrically insulated from the outer package member. The coupling wiring line is electrically insulated from the outer package member and electrically coupled to each of the first electrode and the external terminal. The coupling wiring line includes a first part, a second part that overlaps with the first part, and a turning part that is curved to allow the first part and the second part to be coupled to each other.

### CROSS REFERENCE TO RELATED APPLICATIONS

The present application is a continuation of PCT patent application no. PCT/JP2022/007294, filed on Feb. 22, 2022, which claims priority to Japanese patent application no. 2021-109640, filed on Jun. 30, 2021, the entire contents of which is incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolyte that are contained inside an outer package member. A configuration of the secondary battery has been considered in various ways.

For example, a sealed electrical storage device is disclosed in which an electrode body is contained in an outer casing. In the sealed electrical storage device, the outer casing has a casing body and a cover plate member, for example. The cover plate member is joined, by means of welding, to the casing body at an opening provided on a side opposite to a bottom part of the casing body. Further, a secondary battery is disclosed in which a battery cover is placed over and crimped to a battery can containing a wound electrode body. In addition, a cylindrical battery is disclosed having two positive electrode leads.

### SUMMARY

The present technology relates to a secondary battery.

Although consideration has been given in various ways to improve performance of a secondary battery, physical durability of the secondary battery is not sufficient yet. Accordingly, there is room for improvement in terms thereof.

It is desirable to provide a secondary battery that makes it possible to achieve superior physical durability.

A secondary battery according to an embodiment includes an outer package member, a battery device, an external terminal, and a coupling wiring line. The battery device is placed in the outer package member and includes a first electrode and a second electrode. The external terminal is attached to the outer package member and is electrically insulated from the outer package member. The coupling wiring line is electrically insulated from the outer package member and electrically coupled to each of the first electrode and the external terminal. The coupling wiring line includes a first part, a second part, and a turning part. The second part overlaps with the first part. The turning part is curved to allow the first part and the second part to be coupled to each other.

According to an embodiment, the coupling wiring line includes the turning part that is curved to allow the first part and the second part to be coupled to each other. This makes it possible to achieve superior physical durability.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of the configuration of the secondary battery illustrated in FIG. 1.

FIG. 3 is a sectional view of a configuration of a battery device illustrated in FIG. 2.

FIG. 4 is a partial enlarged sectional view of a positive electrode lead illustrated in FIG. 2 and a portion in the vicinity thereof.

FIG. 5 is a perspective view of a configuration of an outer package can to be used in a process of manufacturing the secondary battery.

FIG. 6 is a sectional view of the configuration of the outer package can illustrated to describe the process of manufacturing the secondary battery.

FIG. 7 is a sectional view of a configuration of a secondary battery according to an embodiment.

FIG. 8 is a sectional view of a configuration of a secondary battery according to an embodiment.

FIG. 9 is a sectional view of a configuration of a secondary battery according to an embodiment.

FIG. 10 is a sectional view of a configuration of a secondary battery according to an embodiment.

FIG. 11 is a sectional view of a configuration of a secondary battery according to an embodiment.

FIG. 12 is a sectional view of a configuration of a secondary battery of Experiment example 2.

FIG. 13 is a sectional view of a configuration of a secondary battery of Experiment example 3.

### DETAILED DESCRIPTION

One or more embodiments of the present technology are described below in further detail including with reference to the drawings.

A description is given first of a secondary battery according to an embodiment of the present technology.

The secondary battery to be described here has a flat and columnar three-dimensional shape, and is commonly referred to by a term such as a coin type or a button type. As will be described later, the secondary battery includes two bottom parts opposed to each other, and a sidewall part lying between the two bottom parts. This secondary battery has a height smaller than an outer diameter. The “outer diameter” is a diameter (a maximum diameter) of each of the two bottom parts. The “height” is a distance (a maximum distance) from a surface of one of the bottom parts to a surface of another of the bottom parts.

Although a charge and discharge principle of the secondary battery is not particularly limited, the following description deals with a case where a battery capacity is obtained using insertion and extraction of an electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains the battery capacity using insertion and extraction of lithium is what is called a lithium-ion secondary battery. In the lithium-ion secondary battery, lithium is inserted and extracted in an ionic state.

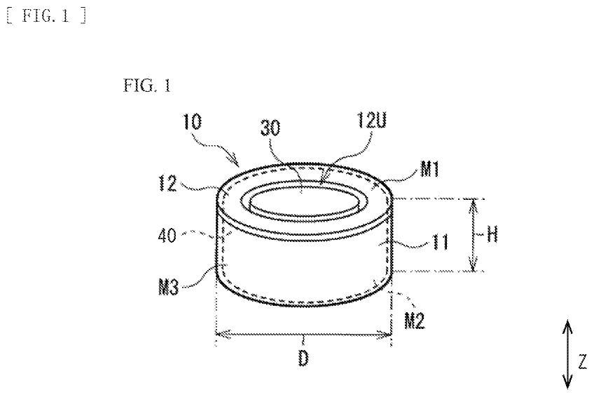

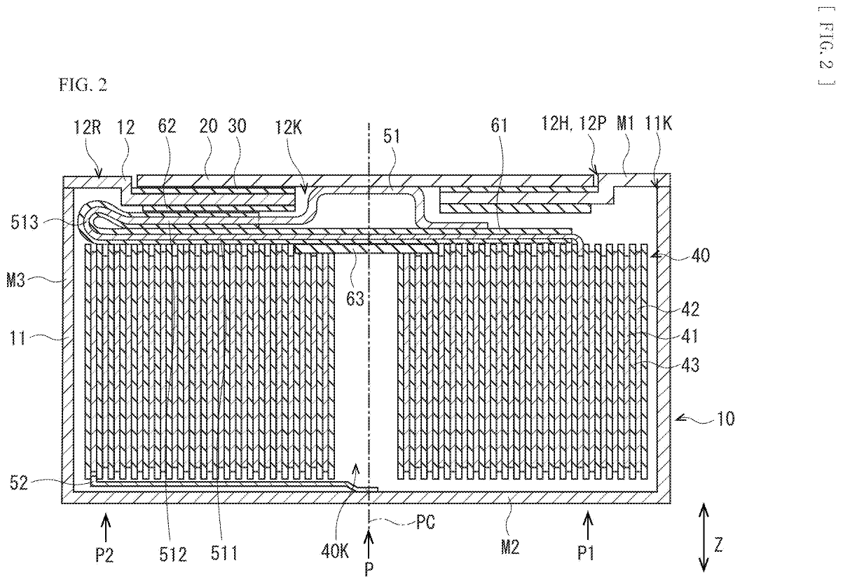

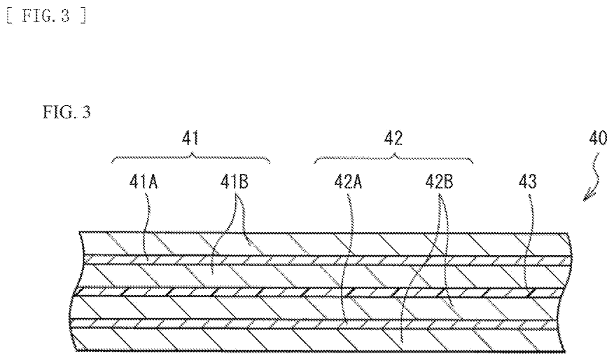

FIG. 1 illustrates a perspective configuration of the secondary battery. FIG. 2 illustrates a sectional configuration of the secondary battery illustrated in FIG. 1. FIG. 3 illustrates a sectional configuration of a battery device 40 illustrated in FIG. 2. Note that in FIG. 2, a positive electrode lead 51 is shaded, and FIG. 3 illustrates only a portion of the sectional configuration of the battery device 40 in an enlarged manner.

For convenience, the following description is given with an upper side of each of FIGS. 1 and 2 assumed as an upper side of the secondary battery, and a lower side of each of FIGS. 1 and 2 assumed as a lower side of the secondary battery.

The secondary battery to be described here has such a three-dimensional shape that a height H is smaller than an outer diameter D, as illustrated in FIG. 1. In other words, the secondary battery has a flat and columnar three-dimensional shape. Here, the three-dimensional shape of the secondary battery is flat and cylindrical (circular columnar).

Dimensions of the secondary battery are not particularly limited. However, for example, the outer diameter D is within a range from 3 mm to 30 mm both inclusive, and the height H is within a range from 0.5 mm to 70 mm both inclusive. Note that a ratio of the outer diameter D to the height H, i.e., D/H, is greater than 1. Although not particularly limited, an upper limit of the ratio D/H is preferably less than or equal to 25.

As illustrated in FIGS. 1 to 3, the secondary battery includes an outer package can 10, an external terminal 20, the battery device 40, and the positive electrode lead 51. Here, the secondary battery further includes a gasket 30, a negative electrode lead 52, a sealant 61, and insulating films 62 and 63.

As illustrated in FIGS. 1 and 2, the outer package can 10 is a hollow outer package member in which the battery device 40 and other components are to be placed.

Here, the outer package can 10 has a flat and circular columnar three-dimensional shape corresponding to the three-dimensional shape of the secondary battery which is flat and circular columnar. Accordingly, the outer package can 10 includes two bottom parts M1 and M2 opposed to each other, and a sidewall part M3 lying between the bottom parts M1 and M2. The sidewall part M3 has an upper end part coupled to the bottom part M1, and a lower end part coupled to the bottom part M2. As described above, the outer package can 10 is cylindrical. Thus, the bottom parts M1 and M2 are each circular in plan shape, and a surface of the sidewall part M3 is a convexly curved surface.

The outer package can 10 includes a container part 11 and a cover part 12 that are welded to each other. The container part 11 is sealed by the cover part 12. In other words, the cover part 12 is welded to the container part 11.

The container part 11 is a container member having a flat and circular columnar shape and allowing the battery device 40 and other components to be placed therein. The container part 11 has a hollow structure with an upper end part open and a lower end part closed, and thus has an opening 11K at the upper end part.

The cover part 12 is a substantially disk-shaped cover member that closes the opening 11K of the container part 11, and has a through hole 12K. The through hole 12K is used as a coupling path for coupling the battery device 40 and the external terminal 20 to each other. As described above, the cover part 12 is welded to the container part 11 at the opening 11K. The external terminal 20 is attached to the cover part 12, and the cover part 12 thus supports the external terminal 20.

In the secondary battery having been completed, the opening 11K has been closed by the cover part 12 because the cover part 12 has already been welded to the container part 11 as described above. It may thus seem that whether the container part 11 has had the opening 11K is no longer recognizable from an external appearance of the secondary battery.

However, if the cover part 12 is welded to the container part 11, welding marks remain on a surface of the outer package can 10, more specifically, at a boundary part between the container part 11 and the cover part 12. Thus, whether the container part 11 has had the opening 11K is recognizable afterward by checking the presence or absence of the welding marks.

Specifically, the welding marks remaining on the surface of the outer package can 10 indicates that the container part 11 has had the opening 11K. In contrast, no welding marks remaining on the surface of the outer package can 10 indicates that the container part 11 has had no opening 11K.

Here, the cover part 12 is so bent as to partly protrude toward an inside of the container part 11 and thus forms a protruding part 12P. Specifically, as viewed from outside the outer package can 10, the cover part 12 has a partly recessed shape. Thus, as viewed from outside the outer package can 10, the protruding part 12P constitutes a recessed part 12H. The through hole 12K is provided in the protruding part 12P or the recessed part 12H. A portion of the cover part 12 other than the protruding part 12P is a peripheral part 12R. The peripheral part 12R is provided to surround the protruding part 12P and has an annular shape in a horizontal plane orthogonal to a height direction Z of the secondary battery.

A shape of the recessed part 12H in a plan view, that is, a shape defined by an outer edge of the recessed part 12H when the secondary battery is viewed from above, is not particularly limited. Here, the recessed part 12H has a substantially circular shape in a plan view. Note that an inner diameter and a depth of the recessed part 12H are each not particularly limited and may be set as desired.

As described above, the outer package can 10 is what is called a welded can in which the container part 11 and the cover part 12 that have been physically separate from each other are welded to each other. Thus, the outer package can 10 after the welding is a single member that is physically integral as a whole, and is in a state of being not separable into the container part 11 and the cover part 12 afterward.

The outer package can 10 that is a welded can is different from a crimped can formed by means of crimping processing, and is what is called a crimpless can. A reason for employing the crimpless can is that this increases a device space volume inside the outer package can 10, and accordingly increases an energy density per unit volume. The “device space volume” refers to a volume (an effective volume) of an internal space of the outer package can 10 available for placing the battery device 40 therein.

Further, the outer package can 10 as the welded can does not include any portion folded over another portion, and does not include any portion in which two or more members lie over each other.

The wording “does not include any portion folded over another portion” means that the outer package can 10 is not so processed (subjected to bending processing) as to include a portion folded over another portion. The wording “does not include any portion in which two or more members lie over each other” means that the outer package can 10 after completion of the secondary battery is physically a single member and is thus not separable into two or more members afterward. That is, the outer package can 10 in the secondary battery having been completed is not in a state where two or more members lie over each other and are so combined with each other as to be separable afterward.

Here, the outer package can 10 is electrically conductive, and therefore each of the container part 11 and the cover part 12 is electrically conductive. The outer package can 10 thus serves as an external coupling terminal for the negative electrode 42, because the outer package can 10 is electrically coupled to the battery device 40 (a negative electrode 42) via the negative electrode lead 52. A reason for employing such a configuration is that this makes it unnecessary for the secondary battery to be provided with an external coupling terminal for the negative electrode 42 separate from the outer package can 10, and therefore suppresses a decrease in device space volume resulting from providing the external coupling terminal for the negative electrode 42. As a result, the device space volume increases, and accordingly, the energy density per unit volume increases.

Specifically, the outer package can 10 includes a metal can including any one or more of electrically conductive materials including, without limitation, a metal material and an alloy material. Examples of the electrically conductive material to be included in the metal can include iron, copper, nickel, stainless steel, an iron alloy, a copper alloy, and a nickel alloy. The stainless steel is not particularly limited in kind, and specific examples thereof include SUS304 and SUS316. Note that the container part 11 and the cover part 12 may include the same material or may include respective different materials.

As will be described later, the cover part 12 is insulated, via the gasket 30, from the external terminal 20 serving as an external coupling terminal for a positive electrode 41. A reason for this is that this prevents contact (a short circuit) between the outer package can 10 (the external coupling terminal for the negative electrode 42) and the external terminal 20 (the external coupling terminal for the positive electrode 41).

As illustrated in FIGS. 1 and 2, the external terminal 20 is a coupling terminal to be coupled to electronic equipment when the secondary battery is mounted on the electronic equipment. As described above, the external terminal 20 is attached to the outer package can 10 (the cover part 12), and is thus supported by the cover part 12.

Here, the external terminal 20 is coupled to the positive electrode 41 of the battery device 40 via the positive electrode lead 51. The external terminal 20 thus serves as the external coupling terminal for the positive electrode 41. Accordingly, upon use of the secondary battery, the secondary battery is coupled to electronic equipment via the external terminal 20 (the external coupling terminal for the positive electrode 41) and the outer package can 10 (the external coupling terminal for the negative electrode 42). This allows the electronic equipment to operate with use of the secondary battery as a power source.

The external terminal 20 is a flat and substantially plate-shaped member, and is disposed inside the recessed part 12H with the gasket 30 interposed therebetween. The external terminal 20 is thus insulated from the cover part 12 via the gasket 30. Here, the external terminal 20 is placed inside the recessed part 12H so as not to protrude above the cover part 12. A reason for this is that this reduces the height H of the secondary battery and therefore increases the energy density per unit volume of the secondary battery, as compared with a case where the external terminal 20 protrudes above the cover part 12.

Note that the external terminal 20 has an outer diameter smaller than an inner diameter of the recessed part 12H. This allows the external terminal 20 to be separate from the cover part 12 surrounding the external terminal 20. Accordingly, the gasket 30 is disposed only in a portion of a region between the external terminal 20 and the cover part 12 (the recessed part 12H). More specifically, the gasket 30 is disposed only at a location where the external terminal 20 and the cover part 12 would be in contact with each other if it were not for the gasket 30.

The external terminal 20 includes any one or more of electrically conductive materials including, without limitation, a metal material and an alloy material. Examples of the electrically conductive materials include aluminum and an aluminum alloy. Note that the external terminal 20 may include a cladding material. The cladding material includes an aluminum layer and a nickel layer that are disposed in order from a side closer to the gasket 30. In the cladding material, the aluminum layer and the nickel layer are roll-bonded to each other.

The gasket 30 is an insulating member disposed between the outer package can 10 (the cover part 12) and the external terminal 20, as illustrated in FIG. 2. The external terminal 20 is fixed to the cover part 12 with the gasket 30 interposed therebetween. Here, the gasket 30 is ring-shaped in a plan view, and has a through hole at a location corresponding to the through hole 12K. The gasket 30 includes any one or more of insulating materials including, without limitation, a polymer compound having an insulating property. Examples of the insulating materials include polypropylene and polyethylene.

A range of placement of the gasket 30 is not particularly limited, and may be chosen as desired. Here, the gasket 30 is disposed in a space between a top surface of the cover part 12 and a bottom surface of the external terminal 20 inside the recessed part 12H.

The battery device 40 is a power generation device that causes charging and discharging reactions to proceed. As illustrated in FIGS. 2 and 3, the battery device 40 is placed inside the outer package can 10. The battery device 40 includes the positive electrode 41 and the negative electrode 42. Here, the battery device 40 further includes a separator 43 and an electrolytic solution. The electrolytic solution is a liquid electrolyte, and is not illustrated.

A center line PC illustrated in FIG. 2 is a line segment corresponding to a center of the battery device 40 in a direction along the outer diameter D of the secondary battery (the outer package can 10). More specifically, a position P of the center line PC corresponds to a center position of the battery device 40.

The battery device 40 is what is called a wound electrode body. More specifically, in the battery device 40, the positive electrode 41 and the negative electrode 42 are stacked on each other with the separator 43 interposed therebetween. In addition, the stack of the positive electrode 41, the negative electrode 42, and the separator 43 is wound. The positive electrode 41 and the negative electrode 42 are wound while remaining opposed to each other with the separator 43 interposed therebetween. As a result, a winding center space 40K is present at the center of the battery device 40.

Here, the positive electrode 41, the negative electrode 42, and the separator 43 are wound in such a manner that the separator 43 is disposed in each of an outermost wind of the wound electrode body and an innermost wind of the wound electrode body. Respective numbers of winds of the positive electrode 41, the negative electrode 42, and the separator 43 are not particularly limited, and may be chosen as desired.

The battery device 40 has a three-dimensional shape similar to the three-dimensional shape of the outer package can 10. The battery device 40 thus has a flat and circular columnar three-dimensional shape. This helps to prevent what is called a dead space, more specifically, a gap between the outer package can 10 and the battery device 40, from resulting easily when the battery device 40 is placed in the outer package can 10, as compared with a case where the battery device 40 has a three-dimensional shape different from the three-dimensional shape of the outer package can 10. This allows for efficient use of the internal space of the outer package can 10. As a result, the device space volume increases, and accordingly, the energy density per unit volume of the secondary battery increases.

The positive electrode 41 is a first electrode to be used to cause the charging and discharging reactions to proceed. As illustrated in FIG. 3, the positive electrode 41 includes a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

The positive electrode active material layer 41B is provided on each of the two opposed surfaces of the positive electrode current collector 41A. The positive electrode active material layer 41B includes any one or more of positive electrode active materials into which lithium is insertable and from which lithium is extractable. Note that the positive electrode active material layer 41B may be provided only on one of the two opposed surfaces of the positive electrode current collector 41A. The positive electrode active material layer 41B may further include other materials including, without limitation, a positive electrode binder and a positive electrode conductor. A method of forming the positive electrode active material layer 41B is not particularly limited, and specific examples thereof include a coating method.

The positive electrode active material includes a lithium compound. The term “lithium compound” is a generic term for a compound that includes lithium as a constituent element. More specifically, the lithium compound is a compound that includes lithium and one or more transition metal elements as constituent elements. A reason for this is that a high energy density is obtainable. Note that the lithium compound may further include any one or more of other elements (excluding lithium and transition metal elements). Although not particularly limited in kind, the lithium compound is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes any one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes any one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 is a second electrode to be used to cause the charging and discharging reactions to proceed. As illustrated in FIG. 3, the negative electrode 42 includes a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

The negative electrode active material layer 42B is provided on each of the two opposed surfaces of the negative electrode current collector 42A. The negative electrode active material layer 42B includes any one or more of negative electrode active materials into which lithium is insertable and from which lithium is extractable. Note that the negative electrode active material layer 42B may be provided only on one of the two opposed surfaces of the negative electrode current collector 42A. The negative electrode active material layer 42B may further include other materials including, without limitation, a negative electrode binder and a negative electrode conductor. Details of the negative electrode binder are similar to the details of the positive electrode binder. Details of the negative electrode conductor are similar to the details of the positive electrode conductor. A method of forming the negative electrode active material layer 42B is not particularly limited, and specifically includes any one or more of methods including, without limitation, a coating method, a vapor-phase method, a liquid-phase method, a thermal spraying method, and a firing (sintering) method.

The negative electrode active material includes a carbon material, a metal-based material, or both. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, any one or more elements among metal elements and metalloid elements that are each able to form an alloy with lithium. Examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Here, the negative electrode 42 has a height greater than a height of the positive electrode 41. More specifically, the negative electrode 42 protrudes above the positive electrode 41, and protrudes below the positive electrode 41. A reason for this is to prevent precipitation of lithium extracted from the positive electrode 41. The “height” is a dimension corresponding to the height H of the secondary battery described above, that is, a dimension in an up-down direction in each of FIGS. 1 and 2. The definition of the height described here applies also to the following.

The separator 43 is an insulating porous film interposed between the positive electrode 41 and the negative electrode 42, as illustrated in FIGS. 2 and 3. The separator 43 allows lithium ions to pass therethrough while preventing a short circuit between the positive electrode 41 and the negative electrode 42. The separator 43 includes a polymer compound such as polyethylene.

Here, the separator 43 has a height greater than the height of the negative electrode 42. More specifically, the separator 43 preferably protrudes above the negative electrode 42 and protrudes below the negative electrode 42. A reason for this is to cause the positive electrode lead 51 to be insulated from the negative electrode 42 using the separator 43, as will be described later.

The electrolytic solution includes a solvent and an electrolyte salt. The positive electrode 41, the negative electrode 42, and the separator 43 are each impregnated with the electrolytic solution. The solvent includes any one or more of non-aqueous solvents (organic solvents) including, without limitation, a carbonic-acid-ester-based compound, a carboxylic-acid-ester-based compound, and a lactone-based compound. An electrolytic solution that includes any of the non-aqueous solvents is what is called a non-aqueous electrolytic solution. The electrolyte salt includes any one or more of light metal salts including, without limitation, a lithium salt.

As illustrated in FIG. 2, the positive electrode lead 51 is placed inside the outer package can 10. The positive electrode lead 51 is a coupling wiring line coupled to each of the positive electrode 41 and the external terminal 20. The secondary battery illustrated in FIG. 2 includes one positive electrode lead 51. Note that the secondary battery may include two or more positive electrode leads 51.

The positive electrode lead 51 is coupled to an upper end part of the positive electrode 41. Specifically, the positive electrode lead 51 is coupled to an upper end part of the positive electrode current collector 41A. Further, the positive electrode lead 51 is coupled to the bottom surface of the external terminal 20 via the through hole 12K provided in the cover part 12. A method of coupling the positive electrode lead 51 is not particularly limited, and specifically includes any one or more of welding methods including, without limitation, a resistance welding method and a laser welding method. The details of the welding methods described here apply also to the following.

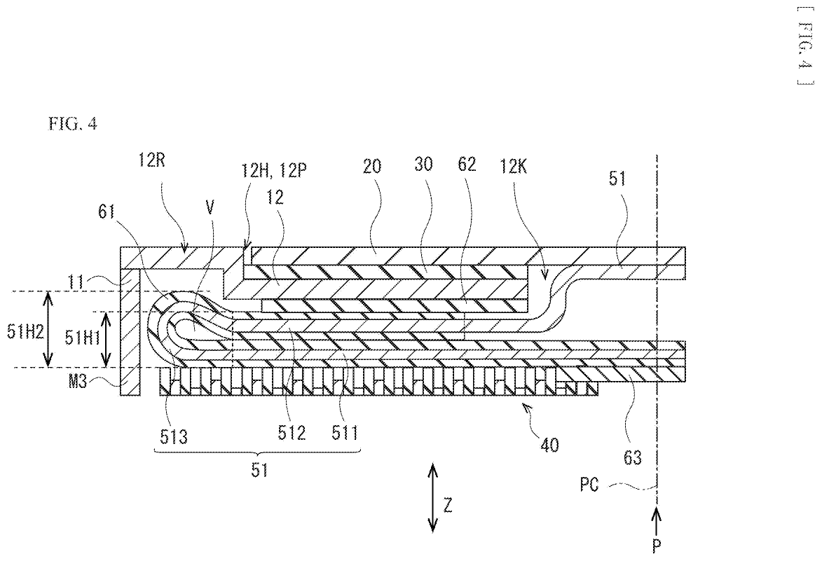

A portion of the positive electrode lead 51 is electrically insulated from each of the cover part 12 of the outer package can 10 and the negative electrode 42 of the battery device 40, and is sandwiched by the cover part 12 and the battery device 40 in the height direction of the secondary battery. FIG. 4 is a partial enlarged sectional diagram illustrating, in the sectional configuration of the secondary battery illustrated in FIG. 2, the positive electrode lead 51 and a portion in the vicinity thereof in an enlarged manner. As illustrated in FIG. 4, the positive electrode lead 51 includes a first part 511, a second part 512, and a turning part 513. The first part 511 and the second part 512 each extend along a horizontal plane orthogonal to the height direction Z of the secondary battery. Further, the first part 511 and the second part 512 overlap with each other in the height direction Z of the secondary battery, with the sealant 61 interposed between the first part 511 and the second part 512. The turning part 513 is curved to allow the first part 511 and the second part 512 to be coupled to each other. Here, the turning part 513 is curved to define a space V inside. The turning part 513 has a thickness 51H2 greater than a thickness 51H1 of an overlap portion of the first part 511 and the second part 512. Note that the thickness 51H1 includes a thickness of the sealant 61 covering each of the first part 511 and the second part 512. Similarly, the thickness 51H2 includes the thickness of the sealant 61 covering the turning part 513. Each of the thicknesses 51H1 and 51H2 is a dimension along the height direction Z of the secondary battery.

The first part 511 and the second part 512 are interposed between the battery device 40 and the protruding part 12P of the cover part 12 in the height direction Z of the secondary battery. However, the turning part 513 is interposed between the battery device 40 and a portion of the cover part 12 other than the protruding part 12P in the height direction Z of the secondary battery. The portion of the cover part 12 other than the protruding part 12P refers here to the peripheral part 12R, of the cover part 12, that surrounds the protruding part 12P. As illustrated in FIG. 4, in the height direction Z of the secondary battery, a spacing between the peripheral part 12R and the battery device 40 is greater than a spacing between the protruding part 12P and the battery device 40. Accordingly, it is possible to dispose the turning part 513, which has the thickness 51H2 greater than the thickness 51H1 of the overlap portion of the first part 511 and the second part 512, in the space between the battery device 40 and the peripheral part 12R, while so disposing the overlap portion as to be interposed between the battery device 40 and the protruding part 12P. This makes it possible for the positive electrode lead 51 to be placed inside the outer package can 10 without any mechanical load on the turning part 513, even if the secondary battery is made smaller in dimension in the height direction.

In this way, the portion of the positive electrode lead 51 is held by the cover part 12 and the battery device 40 by extending along each of a bottom surface of the cover part 12 and a top surface of the battery device 40. This allows the positive electrode lead 51 to be fixed inside the outer package can 10. By preventing the positive electrode lead 51 from easily moving even if the secondary battery undergoes an external force such as vibration or shock, the positive electrode lead 51 is prevented from being damaged easily. Examples of damage to the positive electrode lead 51 include cracking of the positive electrode lead 51, breakage of the positive electrode lead 51, and falling of the positive electrode lead 51 off the positive electrode 41. Further, by providing the positive electrode lead 51 with the turning part 513 that is curved, it is possible to sufficiently reduce the occurrence of the damage to the positive electrode lead 51, as compared with when the positive electrode lead 51 includes a bent portion.

In an embodiment, a portion of the positive electrode lead 51 is sandwiched by the outer package can 10 and the battery device 40. The wording “a portion of the positive electrode lead 51 is sandwiched by the outer package can 10 and the battery device 40” is intended to mean that the positive electrode lead 51 is held by the outer package can 10 and the battery device 40 from above and below while being insulated from each of the outer package can 10 and the battery device 40, and the positive electrode lead 51 is thus in a state of not easily movable inside the outer package can 10 even if the secondary battery undergoes an external force such as vibration or shock. The state where the positive electrode lead 51 is not easily movable inside the outer package can 10 exactly indicates that the battery device 40 is also in a state of not easily movable inside the outer package can 10. This helps to prevent also the battery device 40, i.e., the wound electrode body, from suffering a defect such as winding deformation when the secondary battery undergoes vibration or shock.

Note that the positive electrode lead 51 preferably digs into the battery device 40 due to pressing by the battery device 40. More specifically, because the height of the separator 43 is greater than the height of each of the positive electrode 41 and the negative electrode 42, the positive electrode lead 51 preferably digs into an upper end part of the separator 43. In such a case, a recessed part is formed in the upper end part of the separator 43 due to pressing by the positive electrode lead 51. The positive electrode lead 51 is held by the separator 43 because a portion or all of the positive electrode lead 51 is placed inside the recessed part. A reason for employing such a configuration is that this helps to further prevent the positive electrode lead 51 from moving easily inside the outer package can 10, and thus helps to further prevent the positive electrode lead 51 from being damaged easily.

Here, as described above, the cover part 12 includes the protruding part 12P, and a portion of the positive electrode lead 51 is sandwiched by the protruding part 12P and the battery device 40. More specifically, the portion of the positive electrode lead 51 is held by the protruding part 12P and the battery device 40 by extending along each of the bottom surface of the protruding part 12P and the top surface of the battery device 40. The protruding part 12P helps to hold the positive electrode lead 51 more easily. This further prevents the positive electrode lead 51 from being damaged easily.

Further, the portion of the positive electrode lead 51 is insulated from the cover part 12 and the negative electrode 42 via each of the separator 43, the sealant 61, and the insulating films 62 and 63.

Specifically, as described above, the height of the separator 43 is greater than the height of the negative electrode 42. Accordingly, the portion of the positive electrode lead 51 is separated from the negative electrode 42 via the separator 43, and is thus insulated from the negative electrode 42 via the separator 43. A reason for employing such a configuration is that this prevents a short circuit between the positive electrode lead 51 and the negative electrode 42.

Further, the positive electrode lead 51 is covered at a periphery thereof by the sealant 61 having an insulating property. The portion of the positive electrode lead 51 is thereby insulated from each of the cover part 12 and the negative electrode 42 via the sealant 61. A reason for employing such a configuration is that this prevents a short circuit between the positive electrode lead 51 and the cover part 12, and also prevents a short circuit between the positive electrode lead 51 and the negative electrode 42.

Further, the insulating film 62 is disposed between the cover part 12 and the positive electrode lead 51. The portion of the positive electrode lead 51 is thereby insulated from the cover part 12 via the insulating film 62. A reason for employing such a configuration is that this prevents a short circuit between the positive electrode lead 51 and the cover part 12.

Furthermore, the insulating film 63 is disposed between the battery device 40 and the positive electrode lead 51. The portion of the positive electrode lead 51 is thereby insulated from the negative electrode 42 via the insulating film 63. A reason for employing such a configuration is that this prevents a short circuit between the positive electrode lead 51 and the negative electrode 42.

Details of a material included in the positive electrode lead 51 are similar to the details of the material included in the positive electrode current collector 41A. Note that the material included in the positive electrode lead 51 and the material included in the positive electrode current collector 41A may be the same as or different from each other.

Here, the positive electrode lead 51 is coupled to the positive electrode 41 in a region on a front side relative to the center line PC, that is, a region on the right side relative to the center line PC in FIG. 2. In order for the positive electrode lead 51 to be coupled to the external terminal 20, as illustrated in FIG. 4, the positive electrode lead 51 is provided with the turning part 513 in the middle of extending to the external terminal 20. The turning part 513 lies in a region on a back side relative to the center line PC, that is, a region on the left side relative to the center line PC in FIG. 2. The positive electrode lead 51 includes the first part 511 as a portion extending from a location at which the positive electrode lead 51 is coupled to the positive electrode 41 to the turning part 513 through the center position P. The first part 511 extends along the top surface of the battery device 40 in a direction orthogonal to the height direction Z. The positive electrode lead 51 further includes the second part 512 as an intermediate portion between the turning part 513 and a location at which the positive electrode lead 51 is coupled to the external terminal 20. The second part 512 extends along the top surface of the battery device 40 in the direction orthogonal to the height direction Z in such a manner as to overlie the first part 511. In this way, the portion of the positive electrode lead 51 is sandwiched by the cover part 12 and the battery device 40 in both the region on the front side relative to the center line PC and the region on the back side relative to the center line PC, and extends toward the external terminal 20.

Here, as is apparent from FIG. 2, the “region on the front side relative to the center line PC” refers to, where the battery device 40 is divided into two regions with respect to the center line PC in a direction along the outer diameter D, one of the two regions that includes the location at which the positive electrode lead 51 is coupled to the positive electrode 41. In FIG. 2, the “region on the front side relative to the center line PC” is the region on the right side relative to the center line PC. In contrast, the “region on the back side relative to the center line PC” refers to, as is apparent from FIG. 2, another of the two regions described above, and is the region on the left side relative to the center line PC in FIG. 2. More specifically, the “region on the back side relative to the center line PC” refers to, where the battery device 40 is divided into the two regions with respect to the center line PC in the direction along the outer diameter D, the other of the two regions that does not include any location at which the positive electrode lead 51 is coupled to the positive electrode 41.

A position of coupling of the positive electrode lead 51 to the positive electrode 41 is not particularly limited, and may be chosen as desired. In particular, the positive electrode lead 51 is preferably coupled to the positive electrode 41 on an inner side of winding of the positive electrode 41 relative to an outermost wind of the positive electrode 41. A reason for this is that such a configuration suppresses corrosion of the outer package can 10 resulting from creeping up of the electrolytic solution, unlike when the positive electrode lead 51 is coupled to the positive electrode 41 in the outermost wind of the positive electrode 41. The “creeping up of the electrolytic solution” refers to a phenomenon in which, when the positive electrode lead 51 is disposed in proximity to an inner wall surface of the outer package can 10, the electrolytic solution in the battery device 40 creeps up along the positive electrode lead 51 to reach the inner wall surface of the outer package can 10. The electrolytic solution coming into contact with the outer package can 10 as a result of the “creeping up of the electrolytic solution” causes a phenomenon in which the outer package can 10 dissolves or changes in color.

Here, in a region between the positive electrode 41 and the external terminal 20, the positive electrode lead 51 is turned up once or more and thus lies over itself once or more. The number of times the positive electrode lead 51 is to be turned up is not particularly limited as long as it is once or more. The wording “the positive electrode lead 51 is turned up” means that the positive electrode lead 51 changes its extending direction at an angle greater than 90° in the middle of the positive electrode lead 51. At a location where the positive electrode lead 51 is turned up, the positive electrode lead 51 preferably has a shape that is not bent but is curved, as with the turning part 513 illustrated by way of example in FIG. 4 in an enlarged manner. Although FIGS. 2 and 4 illustrate an example case where the positive electrode lead 51 includes one turning part 513, the positive electrode lead 51 may include multiple turning parts 513.

The positive electrode lead 51 is turned up at the turning part 513 in the middle of extending from the positive electrode 41 to the external terminal 20. Specifically, as illustrated in FIG. 2, the first part 511 extends from a first position P1 to a second position P2 in a horizontal plane orthogonal to the height direction of the secondary battery. The first position P1 is other than the center position P of the outer package can 10. The second position P2 is on a side opposite to the first position P1 as viewed from the center position P. The second part 512 extends from the second position P2 toward the center position P. In the positive electrode lead 51, the overlap portion of the first part 511 and the second part 512 is a surplus portion. It can thus be said that the positive electrode lead 51 has a length margin in a longitudinal direction thereof.

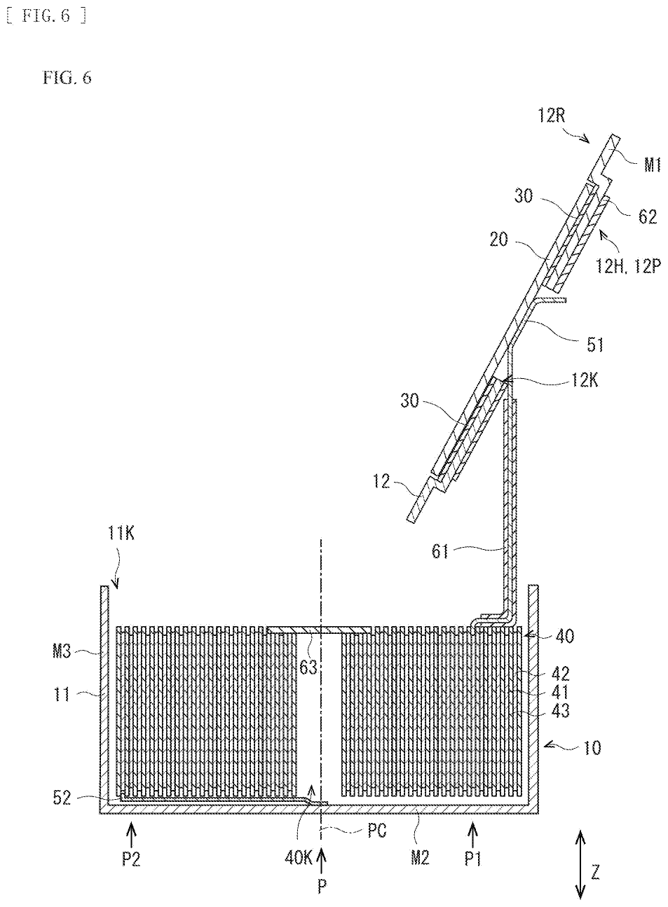

This allows for room to change attitude of the cover part 12 relative to the container part 11 when forming the outer package can 10 using the container part 11 and the cover part 12 in a process of manufacturing the secondary battery, as will be described later. Specifically, it becomes possible to raise the cover part 12 relative to the container part 11, as illustrated in FIG. 6. Further, when the secondary battery undergoes an external force such as vibration or shock, it is possible to mitigate the external force by making use of the length margin of the positive electrode lead 51. This helps to prevent the positive electrode lead 51 from being damaged easily. Furthermore, by making use of the length margin of the positive electrode lead 51, it is possible to change the position of coupling of the positive electrode lead 51 to the positive electrode 41 as desired, without changing the positive electrode lead 51 in length.

In this case, the length (an entire length including the length margin) of the positive electrode lead 51 is not particularly limited, and may be chosen as desired. The length of the positive electrode lead 51 is preferably greater than or equal to half the outer diameter D of the outer package can 10, in particular. A reason for this is that in such a case, a length margin allowing for raising the cover part 12 relative to the container part 11 is ensured for the length of the positive electrode lead 51, which makes it easier to raise the cover part 12 relative to the container part 11.

A range of coupling of the positive electrode lead 51 to the external terminal 20 is not particularly limited. It is preferable that the range of coupling of the positive electrode lead 51 to the external terminal 20 be wide enough for the positive electrode lead 51 to be prevented from easily falling off the external terminal 20 and be narrow enough to allow for the length margin of the positive electrode lead 51, in particular. A reason why the range of coupling of the positive electrode lead 51 to the external terminal 20 is preferably narrow enough is that the narrow range of coupling allows for a sufficiently large length margin of the positive electrode lead 51, because a portion of the positive electrode lead 51 not coupled to the external terminal 20 serves as the length margin.

Note that the positive electrode lead 51 is provided separately from the positive electrode current collector 41A. However, the positive electrode lead 51 may be physically continuous with the positive electrode current collector 41A and may thus be provided integrally with the positive electrode current collector 41A.

As illustrated in FIG. 2, the negative electrode lead 52 is placed inside the outer package can 10. The negative electrode lead 52 is coupled to each of the negative electrode 42 and the outer package can 10 (the container part 11). Here, the secondary battery includes one negative electrode lead 52. However, the secondary battery may include two or more negative electrode leads 52.

The negative electrode lead 52 is coupled to a lower end part of the negative electrode 42, more specifically, a lower end part of the negative electrode current collector 42A. Further, the negative electrode lead 52 is coupled to a bottom surface of the container part 11. Details of methods usable for the coupling of the negative electrode lead 52 are similar to the details of the methods usable for the coupling of the positive electrode lead 51.

Details of a material included in the negative electrode lead 52 are similar to the details of the material included in the negative electrode current collector 42A. Note that the material included in the negative electrode lead 52 and the material included in the negative electrode current collector 42A may be the same as or different from each other.

A position of coupling of the negative electrode lead 52 to the negative electrode 42 is not particularly limited, and may be chosen as desired. Here, the negative electrode lead 52 is coupled to an outermost wind portion of the negative electrode 42 included in the wound electrode body. Note that the negative electrode lead 52 is provided separately from the negative electrode current collector 42A. However, the negative electrode lead 52 may be physically continuous with the negative electrode current collector 42A and may thus be provided integrally with the negative electrode current collector 42A.

The sealant 61 is a first insulating member covering the periphery of the positive electrode lead 51, as illustrated in FIG. 2. The sealant 61 includes two respective insulating tapes attached to a front surface and a back surface of the positive electrode lead 51. Here, to allow the positive electrode lead 51 to be coupled to each of the positive electrode 41 and the external terminal 20, the sealant 61 covers the periphery of a portion in the middle of the positive electrode lead 51. Note that the sealant 61 is not limited to that having a tape-shaped structure, and may have a tube-shaped structure, for example.

The sealant 61 includes any one or more of insulating materials including, without limitation, a polymer compound having an insulating property. Examples of the insulating materials include polyimide.

The insulating film 62 is a second insulating member disposed between the cover part 12 and the positive electrode lead 51, as illustrated in FIG. 2. Here, the insulating film 62 is ring-shaped in a plan view, and has a through hole at a location corresponding to the through hole 12K.

Here, the insulating film 62 may have an adhesive layer (not illustrated) on one surface, and may thus be coupled to either the cover part 12 or the positive electrode lead 51 via the adhesive layer. Alternatively, the insulating film 62 may have respective adhesive layers (not illustrated) on both surfaces, and may thus be coupled to both the cover part 12 and the positive electrode lead 51 via the respective adhesive layers.

The insulating film 62 may include any one or more of insulating materials including, without limitation, a polymer compound having an insulating property. Examples of the insulating materials to be included in the insulating film 62 include polyimide.

The insulating film 63 is a third insulating member disposed between the battery device 40 and the positive electrode lead 51, as illustrated in FIG. 2. Here, the insulating film 63 is flat-plate-shaped in a plan view. The insulating film 63 is disposed to shield the winding center space 40K and to cover the battery device 40 around the winding center space 40K.

Details of a material included in the insulating film 63 are similar to the details of the material included in the insulating film 62. Note that the material included in the insulating film 63 and the material included in the insulating film 62 may be the same as or different from each other.

Note that the secondary battery may further include one or more other components.

Specifically, the secondary battery includes a safety valve mechanism. The safety valve mechanism is to cut off electrical coupling between the outer package can 10 and the battery device 40 if an internal pressure of the outer package can 10 reaches a certain level or higher. Examples of a factor that causes the internal pressure of the outer package can 10 to reach the certain level or higher include the occurrence of a short circuit in the secondary battery and heating of the secondary battery from outside. Although a placement location of the safety valve mechanism is not particularly limited, the safety valve mechanism is preferably placed on either the bottom part M1 or the bottom part M2, more preferably, on the bottom part M2 to which no external terminal 20 is attached, in particular.

Further, the secondary battery may include an insulator between the outer package can 10 and the battery device 40. The insulator includes any one or more of materials including, without limitation, an insulating film and an insulating sheet, and prevents a short circuit between the outer package can 10 and the battery device 40. A range of placement of the insulator is not particularly limited, and may be chosen as desired.

Note that the outer package can 10 is provided with a cleavage valve. The cleavage valve cleaves to release the internal pressure of the outer package can 10 when the internal pressure reaches a certain level or higher. A placement location of the cleavage valve is not particularly limited. However, the cleavage valve is preferably placed on either the bottom part M1 or the bottom part M2, more preferably, on the bottom part M2, in particular, as with the placement location of the safety valve mechanism described above.

Upon charging of the secondary battery, in the battery device 40, lithium is extracted from the positive electrode 41, and the extracted lithium is inserted into the negative electrode 42 via the electrolytic solution. Upon discharging of the secondary battery, in the battery device 40, lithium is extracted from the negative electrode 42, and the extracted lithium is inserted into the positive electrode 41 via the electrolytic solution. Upon the charging and the discharging, lithium is inserted and extracted in an ionic state.

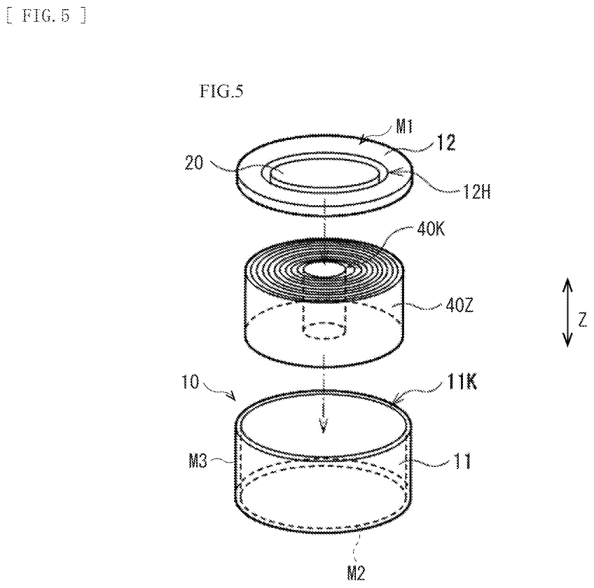

FIG. 5 illustrates a perspective configuration of the outer package can 10 to be used in the process of manufacturing the secondary battery, and corresponds to FIG. 1. FIG. 6 illustrates a sectional configuration of the outer package can 10 for describing the process of manufacturing the secondary battery, and corresponds to FIG. 2.

FIG. 5 illustrates a state where the cover part 12 is separate from the container part 11 before the cover part 12 is welded to the container part 11. FIG. 6 illustrates a state where the cover part 12 is not yet welded to the container part 11 and is raised relative to the container part 11.

In the following description, where appropriate, FIGS. 1 to 4 described already will be referred to in conjunction with FIGS. 5 and 6.

Here, as illustrated in FIG. 5, the container part 11 and the cover part 12 that are physically separate from each other are prepared to form the outer package can 10. The container part 11 is a substantially bowl-shaped member in which the bottom part M2 and the sidewall part M3 are integrated with each other, and has the opening 11K. The cover part 12 is a substantially plate-shaped member corresponding to the bottom part M1. The external terminal 20 is attached in advance to the recessed part 12H provided in the cover part 12, with the gasket 30 interposed between the external terminal 20 and the recessed part 12H.

Alternatively, the bottom part M2 and the sidewall part M3 that are physically separate from each other may be prepared and the container part 11 may be formed by welding the sidewall part M3 to the bottom part M2.

First, the positive electrode active material and other materials including, without limitation, the positive electrode binder and the positive electrode conductor are mixed with each other to thereby produce a positive electrode mixture. Thereafter, the positive electrode mixture thus produced is put into a solvent such as an organic solvent to thereby prepare a positive electrode mixture slurry in paste form. Thereafter, the positive electrode mixture slurry is applied on the two opposed surfaces of the positive electrode current collector 41A to thereby form the positive electrode active material layers 41B. Lastly, the positive electrode active material layers 41B are compression-molded by means of, for example, a roll pressing machine. In this case, the positive electrode active material layers 41B may be heated. The positive electrode active material layers 41B may be compression-molded multiple times. In this manner, the positive electrode 41 is fabricated.

The negative electrode 42 is fabricated by a procedure similar to the fabrication procedure of the positive electrode 41. Specifically, a negative electrode mixture, which is obtained by mixing the negative electrode active material and other materials including, without limitation, the negative electrode binder and the negative electrode conductor with each other, is put into an organic solvent to thereby prepare a negative electrode mixture slurry in paste form, following which the negative electrode mixture slurry is applied on the two opposed surfaces of the negative electrode current collector 42A to thereby form the negative electrode active material layers 42B. Thereafter, the negative electrode active material layers 42B are compression-molded by means of, for example, a roll pressing machine. In this manner, the negative electrode 42 is fabricated.

The electrolyte salt is put into the solvent. The electrolyte salt is thereby dispersed or dissolved in the solvent. Thus, the electrolytic solution is prepared.

First, by means of a welding method such as a resistance welding method, the positive electrode lead 51 covered at the periphery thereof by the sealant 61 is coupled to the positive electrode 41 (the positive electrode current collector 41A), and the negative electrode lead 52 is coupled to the negative electrode 42 (the negative electrode current collector 42A).

Thereafter, the positive electrode 41 and the negative electrode 42 are stacked on each other with the separator 43 interposed therebetween, following which the stack including the positive electrode 41, the negative electrode 42, and the separator 43 is wound to thereby fabricate a wound body 40Z, as illustrated in FIG. 5. The wound body 40Z has a configuration similar to the configuration of the battery device 40 except that the positive electrode 41, the negative electrode 42, and the separator 43 are each unimpregnated with the electrolytic solution. Note that FIG. 5 omits the illustration of each of the positive electrode lead 51 and the negative electrode lead 52.

Thereafter, the wound body 40Z with the positive electrode lead 51 and the negative electrode lead 52 each coupled thereto is placed into the container part 11 through the opening 11K. In this case, the negative electrode lead 52 is coupled to the container part 11 by means of a welding method such as a resistance welding method. Thereafter, the insulating film 63 is placed on the wound body 40Z.

Thereafter, prepared is the cover part 12 to which the external terminal 20 is attached in advance with the gasket 30 interposed therebetween and on which the insulating film 62 is provided in advance. The positive electrode lead 51 is thereafter coupled to the external terminal 20 via the through hole 12K by means of a welding method such as a resistance welding method.

The wound body 40Z (the positive electrode 41) placed inside the container part 11 and the external terminal 20 attached to the cover part 12 are thereby coupled to each other via the positive electrode lead 51. It thus becomes possible to raise the cover part 12 relative to the container part 11, as illustrated in FIG. 6, in a state where the wound body 40Z and the external terminal 20 are coupled to each other via the positive electrode lead 51. A reason for raising the cover part 12 relative to the container part 11 is to prevent the cover part 12 from closing the opening 11K. In raising the cover part 12, a holding jig may be used to hold the cover part 12.

As is apparent from FIG. 6, what is meant by “raise the cover part 12 relative to the container part 11” is to so dispose the cover part 12 as to be substantially orthogonal to the bottom surface of the container part 11 while keeping a state where the battery device 40 and the external terminal 20 are coupled to each other via the positive electrode lead 51. In this case, by making the length of the positive electrode lead 51 sufficiently large, the positive electrode lead 51 is prevented from being under excessive tension or becoming twisted even upon raising the cover part 12 relative to the container part 11. By raising the cover part 12 relative to the container part 11, the cover part 12 is disposed on an inner side, that is, on an interior side of the container part 11 whereas the positive electrode lead 51 is disposed on an outer side, that is, on a side opposite to the interior side of the container part 11. This helps to prevent any foreign matter generated upon welding from easily entering into the container part 11 when the positive electrode lead 51 is welded to the external terminal 20 by means of, for example, a laser welding method.

Thereafter, the electrolytic solution is injected into the container part 11 through the opening 11K. In this case, because the opening 11K is not closed by the cover part 12 as described above, the electrolytic solution is easily injectable into the container part 11 through the opening 11K even if the battery device 40 and the external terminal 20 are coupled to each other via the positive electrode lead 51. The wound body 40Z including the positive electrode 41, the negative electrode 42, and the separator 43 is thereby impregnated with the electrolytic solution. Thus, the battery device 40, i.e., the wound electrode body, is fabricated.

Thereafter, the cover part 12 is tilted to be brought closer to the container part 11 to thereby close the opening 11K with the cover part 12, following which the cover part 12 is welded to the container part 11 by means of a welding method such as a laser welding method. In this case, as illustrated in FIG. 2, a portion of the positive electrode lead 51 is caused to be sandwiched between the cover part 12 and the battery device 40, and the turning part 513 that is curved is formed on the front side relative to the location where the positive electrode lead 51 is coupled to the external terminal 20. In this manner, the outer package can 10 is formed, and the battery device 40 and other components are placed inside the outer package can 10. Assembly of the secondary battery is thus completed.

The secondary battery after being assembled is charged and discharged. Various conditions including, for example, an environment temperature, the number of times of charging and discharging (the number of cycles), and charging and discharging conditions, may be chosen as desired. As a result, a film is formed on a surface of, for example, the negative electrode 42. This brings the secondary battery into an electrochemically stable state. The secondary battery is thus completed.

As described above, according to the secondary battery of the present embodiment, the positive electrode lead 51 includes the turning part 513 that is curved to allow the first part 511 and the second part 512 to be coupled to each other. This increases durability of the positive electrode lead 51. A reason for this is that a local stress concentration is prevented from easily occurring even on the turning part 513, and as a result, the positive electrode lead 51 is prevented from easily suffering cracking or breakage. Accordingly, the secondary battery of the present embodiment makes it possible to achieve superior physical durability.

In particular, the turning part 513 of the positive electrode lead 51 is curved to define the space V inside. This further prevents a local stress from being easily generated in the turning part 513.

Further, in the secondary battery according to the present embodiment, the cover part 12 is provided with the recessed part 12H, and the external terminal 20 is disposed in the recessed part 12H. This helps to reduce a height dimension of the secondary battery while ensuring a battery capacity. Furthermore, in the secondary battery according to the present embodiment, the first part 511 and the second part 512 are interposed between the protruding part 12P of the cover part 12 and the battery device 40 in the height direction of the secondary battery, whereas the turning part 513 is interposed between the peripheral part 12R of the cover part 12 and the battery device 40 in the height direction of the secondary battery. Thus, the turning part 513, which is a relatively thick portion of the positive electrode lead 51, is disposed in a relatively wide space, while the overlap portion of the first part 511 and the second part 512, which is a relatively thin portion of the positive electrode lead 51, is disposed in a relatively narrow space. This allows for more efficient use of the internal space of the outer package can 10, and thus allows for further reduction in thickness of the secondary battery. Accordingly, the secondary battery of the present embodiment is suitable to achieving both improved energy density per unit volume and improved physical durability.

Further, in the secondary battery according to the present embodiment, the turning part 513 is located at a position corresponding to the peripheral part 12R of the cover part 12 in the height direction of the secondary battery, and the first part 511 and the second part 512 extend in a radial direction of the secondary battery from the center position of the secondary battery toward the peripheral part 12R. Specifically, the first part 511 extends from the first position P1 to the second position P2 in a horizontal plane orthogonal to the height direction Z of the secondary battery, the first position P1 being other than the center position P of the outer package can 10, the second position P2 being on the side opposite to the first position P1 as viewed from the center position P. The second part 512 extends from the second position P2 toward the center position. The overlap portion of the first part 511 and the second part 512 is sandwiched and held by the protruding part 12P and the battery device 40. This helps to ensure that the first part 511 is in contact with the battery device 40 over a larger area with the sealant 61 interposed between the first part 511 and the battery device 40, and that the second part 512 is in contact with the protruding part 12P over a larger area directly or with the sealant 61 interposed between the second part 512 and the protruding part 12P. Accordingly, movements of the positive electrode lead 51 and the battery device 40 inside the outer package can 10 are sufficiently limited. This helps to prevent a defect, such as damage to the positive electrode lead 51 or winding deformation of the battery device 40, from easily occurring even when the secondary battery undergoes shock or vibration. The secondary battery according to the present embodiment thus makes it possible to achieve superior physical durability.

In particular, the above-described action and effects are achievable by the secondary battery according to the present embodiment for reasons described below.

The secondary battery according to the present embodiment, which is referred to by the term such as the coin type or the button type, that is, the secondary battery having a flat and columnar three-dimensional shape, includes the external terminal 20 that is small in size and serves as the external coupling terminal for the positive electrode 41, as is apparent from FIGS. 1 and 2. In this case, an area of contact of the positive electrode lead 51 with the external terminal 20 is small due to the small size of the external terminal 20. Accordingly, it is necessary to sufficiently fix the positive electrode lead 51 inside the outer package can 10 in order to maintain the state where the external terminal 20 and the positive electrode lead 51 are electrically coupled to each other.

In this regard, according to the secondary battery of the present embodiment, movement of the positive electrode lead 51 inside the outer package can 10 is sufficiently suppressed, which makes it highly unlikely that the positive electrode lead 51 will come off the external terminal 20 or be broken even if the area of contact of the positive electrode lead 51 with the external terminal 20 is small. Accordingly, the secondary battery of the present embodiment makes it possible to favorably maintain the state where the external terminal 20 and the positive electrode lead 51 are electrically coupled to each other even when the secondary battery undergoes an external force such as vibration or shock. The secondary battery according to the present embodiment therefore makes it possible to achieve high physical durability even if reduced in size.

Further, in the secondary battery according to the present embodiment including the small-sized external terminal 20 serving as the external coupling terminal for the positive electrode 41, the cover part 12 of the outer package can 10 serving as the external coupling terminal for the negative electrode 42 is disposed in proximity to the external terminal 20, as is apparent form FIG. 2. In other words, the cover part 12 and the external terminal 20 which are two external coupling terminals having respective polarities different from each other are located close to each other. Accordingly, to prevent a short circuit between the cover part 12 and the external terminal 20, it is desirable that the area of contact of the positive electrode lead 51 with the external terminal 20 be sufficiently made smaller and that the positive electrode lead 51 be located sufficiently away from the cover part 12.

In this regard, according to the secondary battery of the present embodiment, movement of the positive electrode lead 51 inside the outer package can 10 is sufficiently suppressed, which makes it highly unlikely that the positive electrode lead 51 will come off the external terminal 20 or be broken even if the area of contact of the positive electrode lead 51 with the external terminal 20 is small. Accordingly, the secondary battery of the present embodiment makes it possible to favorably maintain the state where the external terminal 20 and the positive electrode lead 51 are electrically coupled to each other even when the secondary battery undergoes an external force such as vibration or shock. The secondary battery according to the present embodiment therefore makes it possible to achieve high physical durability while preventing a short circuit between the cover part 12 and the external terminal 20, even if reduced in size.

Further, the height of the separator 43 having an insulating property may be greater than the height of the negative electrode 42, and a portion of the positive electrode lead 51 may be insulated from the negative electrode 42 via the separator 43. In such a case, a short circuit between the positive electrode lead 51 and the negative electrode 42 is prevented, and accordingly, it is possible to achieve higher reliability.

In this case, the positive electrode 41 and the negative electrode 42 may be opposed to each other with the separator 43 interposed therebetween and be wound, and the positive electrode lead 51 may be coupled to the positive electrode 41 on the inner side of the winding of the positive electrode 41 relative to the outermost wind of the positive electrode 41. In such a case, corrosion of the outer package can 10 resulting from creeping up of the electrolytic solution is suppressed. Accordingly, it is possible to achieve further higher reliability.

Further, the sealant 61 may cover the periphery of the positive electrode lead 51, and a portion of the positive electrode lead 51 may be insulated from each of the outer package can 10 and the negative electrode 42 via the sealant 61. In such a case, a short circuit between the positive electrode lead 51 and the outer package can 10 is prevented, and a short circuit between the positive electrode lead 51 and the negative electrode 42 is also prevented. Accordingly, it is possible to achieve higher reliability.

In this case, in particular, covering the periphery of the positive electrode lead 51 with the sealant 61 provides the following effects. When the positive electrode lead 51 is sandwiched by the outer package can 10 and the battery device 40 with the sealant 61 interposed therebetween, a grip force is generated between the outer package can 10 and the sealant 61, and also between the battery device 40 and the sealant 61. As a result, it becomes easier for the positive electrode lead 51 to be held by the outer package can 10 and the battery device 40 with the help of the grip force supplied to the positive electrode lead 51 via the sealant 61. As a result, the positive electrode lead 51 is insulated from the outer package can 10 and the negative electrode 42 via the sealant 61. In addition, it becomes further easier for the positive electrode lead 51 to be fixed inside the outer package can 10 with the help of the sealant 61. This makes it possible to achieve further higher physical durability.

Further, the insulating film 62 may be disposed between the outer package can 10 and the positive electrode lead 51, and a portion of the positive electrode lead 51 may be insulated from the outer package can 10 via the insulating film 62. In such a case, a short circuit between the positive electrode lead 51 and the outer package can 10 is prevented. Accordingly, it is possible to achieve higher reliability.

Further, the insulating film 63 may be disposed between the battery device 40 and the positive electrode lead 51, and a portion of the positive electrode lead 51 may be insulated from the negative electrode 42 via the insulating film 63. In such a case, a short circuit between the positive electrode lead 51 and the negative electrode 42 is prevented. Accordingly, it is possible to achieve higher reliability.

Further, the outer package can 10 includes the container part 11 and the cover part 12 that are welded to each other, and the positive electrode lead 51 is turned up once or more. This provides a length margin of the positive electrode lead 51. It thus becomes possible to raise the cover part 12 relative to the container part 11 in the process of manufacturing the secondary battery, particularly in a process of forming the outer package can 10. This allows for easy injection of the electrolytic solution, and furthermore, allows for changing the position of coupling of the positive electrode lead 51 to the positive electrode 41 as desired. Accordingly, it is possible to achieve higher easiness of manufacture.

In this case, the length of the positive electrode lead 51 may be greater than or equal to half the outer diameter D of the outer package can 10. In such a case, it becomes easier to raise the cover part 12 relative to the container part 11 in the process of manufacturing the secondary battery. Accordingly, it is possible to achieve further higher easiness of manufacture.

Further, the secondary battery may have a flat and columnar shape, that is, the secondary battery may be one that is referred to by the term such as the coin type or the button type. In such a case, the positive electrode lead 51 is prevented from being damaged easily even in a small-sized secondary battery that is highly constrained in terms of size. Accordingly, it is possible to achieve higher effects in terms of physical durability.

Further, the secondary battery may be a lithium-ion secondary battery. In such a case, it is possible to obtain a sufficient battery capacity stably through the use of insertion and extraction of lithium.

The configuration of the secondary battery described herein is appropriately modifiable including, for example, as described below. Note that any two or more of the following series of modifications may be combined with each other.

In FIG. 2, the secondary battery includes the sealant 61 and the insulating films 62 and 63. However, as long as the positive electrode lead 51 is insulated from each of the outer package can 10 and the negative electrode 42, the secondary battery of the technology does not necessarily have to include all of the sealant 61 and the insulating films 62 and 63.

To be more specific, firstly, the insulating film 63 may be omitted from the secondary battery when the positive electrode lead 51 is insulated from the negative electrode 42 via the separator 43. Secondly, the insulating film 62, the insulating film 63, or both may be omitted from the secondary battery when the positive electrode lead 51 is insulated from each of the outer package can 10 and the negative electrode 42 via the sealant 61. Thirdly, the sealant 61, the insulating film 63, or both may be omitted from the secondary battery when the positive electrode lead 51 is insulated from each of the outer package can 10 and the negative electrode 42 via the separator 43 and the insulating film 62.

Even in such cases, the positive electrode lead 51 is insulated from each of the outer package can 10 and the negative electrode 42, and it is therefore possible to achieve effects similar to the effects achievable with the secondary battery according to the above-described embodiment.

In FIG. 2, the height of the separator 43 is greater than the height of the negative electrode 42, and thus the positive electrode lead 51 is insulated from the negative electrode 42 via the separator 43. However, when a range of placement of the insulating film 63 is extended to allow the positive electrode lead 51 to be insulated from the negative electrode 42 via the insulating film 63, the separator 43 does not have to be adapted to insulate the positive electrode lead 51 from the negative electrode 42.

Even in such a case, the positive electrode lead 51 is insulated from the negative electrode 42 via the insulating film 63, and it is therefore possible to achieve effects similar to the effects achievable with the secondary battery according to the above-described embodiment. However, to prevent precipitation of lithium extracted from the positive electrode 41, the height of the separator 43 is preferably greater than the height of the negative electrode 42.

In FIG. 2, the insulating film 62 covers only the bottom surface of the cover part 12 (the protruding part 12P). However, a range of placement of the insulating film 62 is not particularly limited as long as a portion of the positive electrode lead 51 is insulated from the outer package can 10 via the insulating film 62.

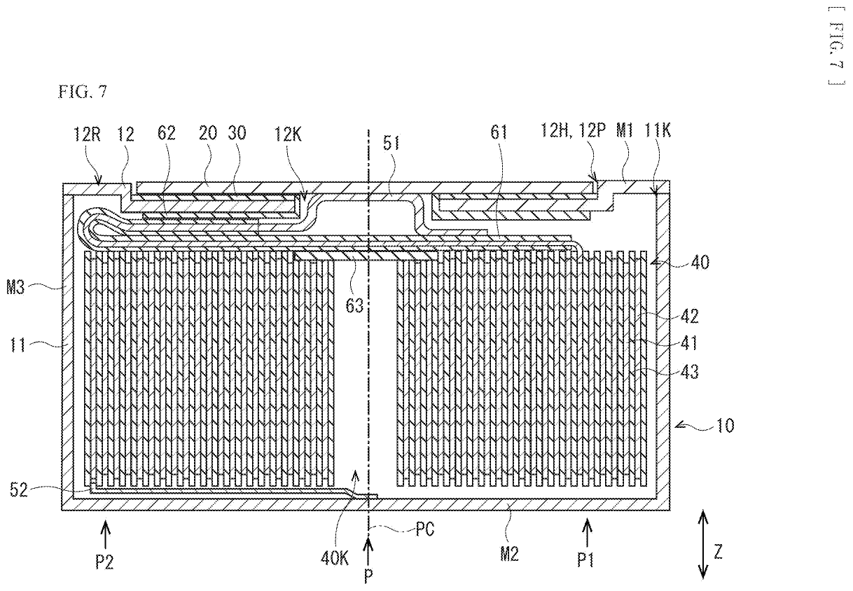

Specifically, as illustrated in FIG. 7 corresponding to FIG. 2, the insulating film 62 may cover not only the bottom surface of the cover part 12 but also a side surface of the cover part 12, that is, an inner wall surface of the through hole 12K. In such a case, a portion of the positive electrode lead 51 that is not covered by the sealant 61 and is thus exposed is prevented from coming into contact with the cover part 12 easily. Accordingly, a short circuit between the positive electrode lead 51 and the outer package can 10 is prevented further. This makes it possible to achieve higher reliability.

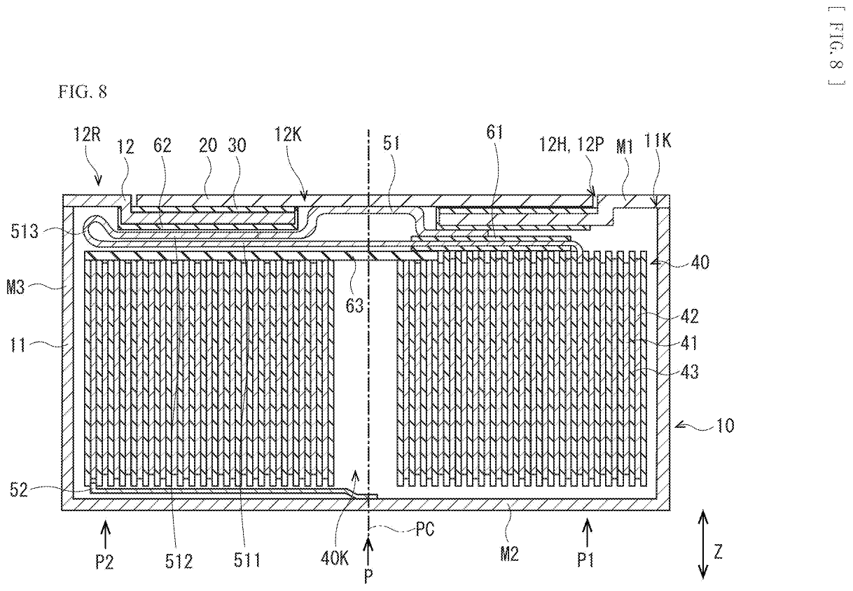

In the disclosure, a range of the positive electrode lead 51 to be covered by the sealant 61 is not particularly limited, and may be chosen as desired. Specifically, as illustrated in FIG. 8 corresponding to FIG. 2, any of the turning part 513, the second part 512, and a portion of the first part 511, of the positive electrode lead 51 does not necessarily have to be covered by the sealant 61. In FIG. 8, a portion of the first part 511 overlapping with the second part 512 is not covered by the sealant 61. Note that the electrical insulation between the positive electrode lead 51 and the battery device 40 is achieved by the insulating film 63.

In FIG. 8, the overlap portion of the first part 511 and the second part 512 is not covered by the sealant 61. This allows the overlap portion of the first part 511 and the second part 512 to be smaller in thickness. Further, in FIG. 8, the turning part 513 is not covered by the sealant 61, either. This allows also the turning part 513 to be smaller in thickness. Accordingly, it is possible to further increase a volume occupancy ratio of the battery device 40 inside the outer package can 10. The secondary battery as illustrated in FIG. 8 is thus more suited to improvement in energy density per unit volume.

According to the secondary battery of FIG. 2 described in the foregoing embodiment, as compared with FIG. 8, it is easier for the positive electrode lead 51 to be insulated from the outer package can 10 and the negative electrode 42 via the sealant 61. This makes it possible to achieve higher reliability.

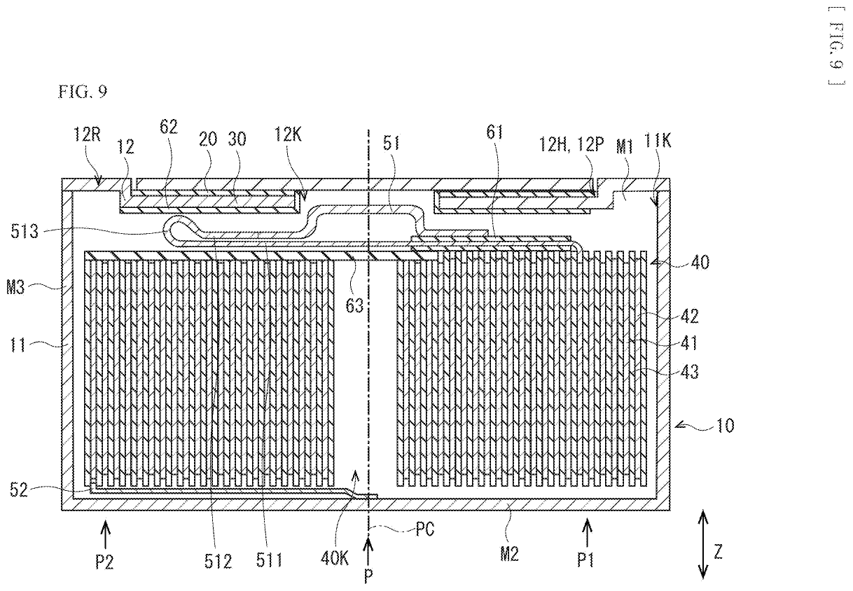

The disclosure is not limited to a case where the turning part 513 of the positive electrode lead 51 is disposed at a position corresponding to the peripheral part 12R of the cover part 12. Specifically, as illustrated in FIG. 9 corresponding to FIG. 8, the turning part 513 may be provided in a space between the protruding part 12P of the cover part 12 and the battery device 40. In FIG. 9 also, the turning part 513 of the positive electrode lead 51 has a curved shape, which makes it possible to reduce the possibility of occurrence of damage to the positive electrode lead 51. However, in FIG. 9, the space between the protruding part 12P and the battery device 40 is to be made larger than the thickness of the turning part 513 in the height direction Z of the secondary battery. From the viewpoint of achieving an improved energy density per unit volume, it is therefore desirable that the turning part 513 be disposed in the space between the peripheral part 12R of the cover part 12 and the battery device 40, as in the configuration examples illustrated in, for example, FIGS. 2, 7, and 8, rather than in FIG. 9.

In FIG. 2, the outer package can 10 is used in which the flat external terminal 20 is attached to an outer side of the cover part 12 including the protruding part 12P (or the recessed part 12H). However, the configuration of the outer package can 10 is not particularly limited, and may be changed as desired. Note that a series of secondary batteries to be described below has a configuration similar to the configuration of the secondary battery illustrated in FIG. 2, except that the configuration of each of the cover part 12 and the external terminal 20 is different.

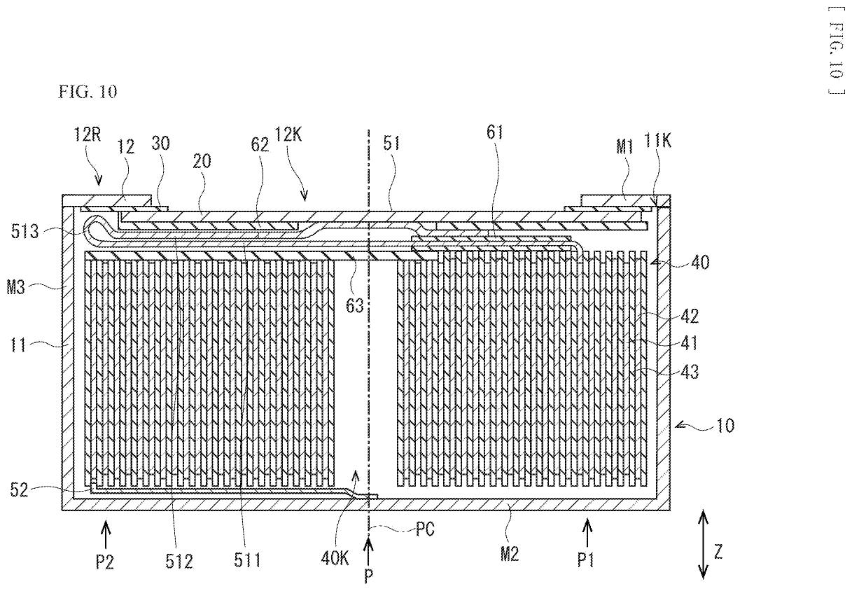

Specifically, as illustrated in FIG. 10 corresponding to FIG. 2, the outer package can 10 may be used in which the flat external terminal 20 is attached to an inner side of the cover part 12 that is flat and includes no protruding part 12P. In this outer package can 10, the flat external terminal 20 is attached to the inner side of the cover part 12 having the through hole 12K, with the gasket 30 interposed between the external terminal 20 and the cover part 12. The external terminal 20 is exposed in part at the through hole 12K. In this case, a placement location of the insulating film 63 may be adjusted in order to suppress a short circuit between the negative electrode 42 and a portion of the positive electrode lead 51 not covered at the periphery thereof by the sealant 61.

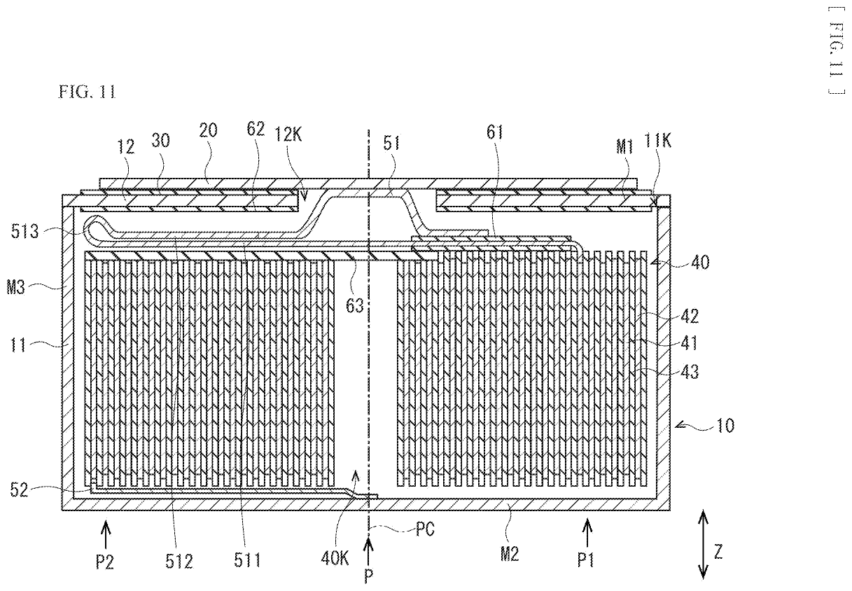

Alternatively, as illustrated in FIG. 11 corresponding to FIG. 2, the outer package can 10 may be used in which the flat external terminal 20 is attached to the outer side of the cover part 12 that is flat and includes no protruding part 12P. In the outer package can 10, the external terminal 20 is attached to the outer side of the cover part 12 having the through hole 12K, with the gasket 30 interposed between the external terminal 20 and the cover part 12.

### Examples

Examples of the present technology are described below according to an embodiment.

As described below, secondary batteries (lithium-ion secondary batteries) were fabricated, and thereafter the secondary batteries were evaluated for their performance.

### [Fabrication of Secondary Battery]

Here, the secondary battery illustrated in FIGS. 1 to 4 was fabricated as a secondary battery of Experiment example 1. In addition, secondary batteries of Experiment examples 2 to 4 were also fabricated. Descriptions thereof will be given below in order.

### Experiment Example 1

In accordance with a procedure described below, fabricated was a secondary battery of the coin type provided with the positive electrode lead 51 including the turning part 513 having a curved shape.

### (Fabrication of Positive Electrode)

First, 91 parts by mass of the positive electrode active material (LiCoO₂), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into an organic solvent (N-methyl-2-pyrrolidone), following which the organic solvent was stirred to thereby prepare a positive electrode mixture slurry in paste form. Thereafter, the positive electrode mixture slurry was applied on the two opposed surfaces of the positive electrode current collector 41A (a band-shaped aluminum foil having a thickness of 12 μm) by means of a coating apparatus, following which the applied positive electrode mixture slurry was dried to thereby form the positive electrode active material layers 41B. Lastly, the positive electrode active material layers 41B were compression-molded by means of a roll pressing machine. In this manner, the positive electrode 41 having a width of 3.3 mm was fabricated.

### (Fabrication of Negative Electrode)

First, 95 parts by mass of the negative electrode active material (graphite) and 5 parts by mass of the negative electrode binder (polyvinylidene difluoride) were mixed with each other to thereby obtain a negative electrode mixture. Thereafter, the negative electrode mixture was put into an organic solvent (N-methyl-2-pyrrolidone), following which the organic solvent was stirred to thereby prepare a negative electrode mixture slurry in paste form. Thereafter, the negative electrode mixture slurry was applied on the two opposed surfaces of the negative electrode current collector 42A (a band-shaped copper foil having a thickness of 15 μm) by means of a coating apparatus, following which the applied negative electrode mixture slurry was dried to thereby form the negative electrode active material layers 42B. Lastly, the negative electrode active material layers 42B were compression-molded by means of a roll pressing machine. In this manner, the negative electrode 42 having a width of 3.8 mm was fabricated.

### (Preparation of Electrolytic Solution)

The electrolyte salt (LiPF₆) was added to the solvent (ethylene carbonate and diethyl carbonate), following which the solvent was stirred. In this case, a mixture ratio (a weight ratio) between ethylene carbonate and diethyl carbonate in the solvent was set to 30:70, and a content of the electrolyte salt was set to 1 mol/kg with respect to the solvent. The electrolyte salt was thereby dissolved or dispersed in the solvent. Thus, the electrolytic solution was prepared.

### (Assembly of Secondary Battery)

First, the positive electrode lead 51 (0.1 mm in thickness, 2.0 mm in width, and 11.7 mm in protrusion length from the positive electrode 41) including aluminum and covered in part at the periphery thereof by the sealant 61 (a polypropylene film) was welded to the positive electrode 41 (the positive electrode current collector 41A) by means of a resistance welding method. The sealant 61 had a tube shape and was 9.0 mm in outer diameter and 3.0 mm in inner diameter. Further, the negative electrode lead 52 (0.1 mm in thickness, 2.0 mm in width, and 6.0 mm in protrusion length from the negative electrode 42) including nickel was welded to the negative electrode 42 (the negative electrode current collector 42A) by means of a resistance welding method. In this case, a position of welding of the positive electrode lead 51 was adjusted to be in the middle of the winding of the positive electrode 41.

Thereafter, the positive electrode 41 and the negative electrode 42 were stacked on each other with the separator 43 (a fine-porous polyethylene film having a thickness of 25 μm and a width of 4.0 mm) interposed therebetween, following which the stack of the positive electrode 41, the negative electrode 42, and the separator 43 was wound to thereby fabricate the wound body 40Z having a cylindrical shape (11.6 mm in outer diameter) and having the winding center space 40K (2.0 mm in inner diameter).

Thereafter, a ring-shaped underlay insulating film (a polyimide film, 11.6 mm in outer diameter, 2.2 mm in inner diameter, and 0.05 mm in thickness) was placed, through the opening 11K, into the container part 11 having a cylindrical shape (0.15 mm in thickness, 12.0 mm in outer diameter, and 5.0 mm in height) and including stainless steel (SUS316), following which the wound body 40Z was placed into the container part 11. In this case, the negative electrode lead 52 was welded to the container part 11 by means of a resistance welding method. Thereafter, by means of a resistance welding method, the positive electrode lead 51 was welded to the external terminal 20 attached to the cover part 12 with the gasket 30 (a polyimide film, 9.2 mm in outer diameter and 3.2 mm in inner diameter) interposed therebetween. The external terminal 20 was disk-shaped (0.3 mm in thickness and 7.2 mm in outer diameter) and included aluminum. The cover part 12 was disk-shaped (0.15 mm in thickness and 11.7 mm in outer diameter), included stainless steel (SUS316), and had the recessed part 12H (9.0 mm in inner diameter and 0.3 mm in step height) with the through hole 12K (3.0 mm in inner diameter) provided therein.

Thereafter, with the cover part 12 being raised relative to the container part 11, the electrolytic solution was injected into the container part 11 through the opening 11K. The wound body 40Z (including the positive electrode 41, the negative electrode 42, and the separator 43) was thereby impregnated with the electrolytic solution. In this manner, the battery device 40 was fabricated.

Lastly, the opening 11K was closed with the cover part 12, following which the cover part 12 was welded to the container part 11 by means of a laser welding method. In closing the opening 11K with the cover part 12, the turning part 513 was formed in a portion of the positive electrode lead 51 in such a manner that the turning part 513 had a curved shape and was located at a position corresponding to the peripheral part 12R of the cover part 12 in the height direction of the secondary battery. Specifically, a distance from the turning part 513 to an inner surface of the sidewall part M3 was adjusted to be 0.5 mm. Further, the insulating film 62 having a ring shape (a polyimide film, 9.2 mm in outer diameter and 3.2 mm in inner diameter) was disposed between the cover part 12 and the positive electrode lead 51, and the insulating film 63 having a disk shape (a polyimide film, 3.2 mm in outer diameter) was disposed between the battery device 40 and the positive electrode lead 51. In this manner, the outer package can 10 was formed using the container part 11 and the cover part 12, and the battery device 40 was sealed in the outer package can 10. The secondary battery having an outer diameter of 12.0 mm and a height of 5.0 mm was thus assembled.

### (Stabilization of Secondary Battery)

The secondary battery after being assembled was charged and discharged for one cycle in an ambient temperature environment (at a temperature of 23° C.). Upon the charging, the secondary battery was charged with a constant current of 0.1 C until a voltage reached 4.2 V, and was thereafter charged with a constant voltage of 4.2 V until a current reached 0.05 C. Upon the discharging, the secondary battery was discharged with a constant current of 0.1 C until the voltage reached 3.0 V. Note that 0.1 C was a value of a current that caused the battery capacity (a theoretical capacity) to be completely discharged in 10 hours, and 0.05 C was a value of a current that caused the battery capacity to be completely discharged in 20 hours.

As a result, a film was formed on the surface of, for example, the negative electrode 42, which brought the secondary battery into an electrochemically stable state. Thus, the secondary battery was completed.

### Experiment Example 2

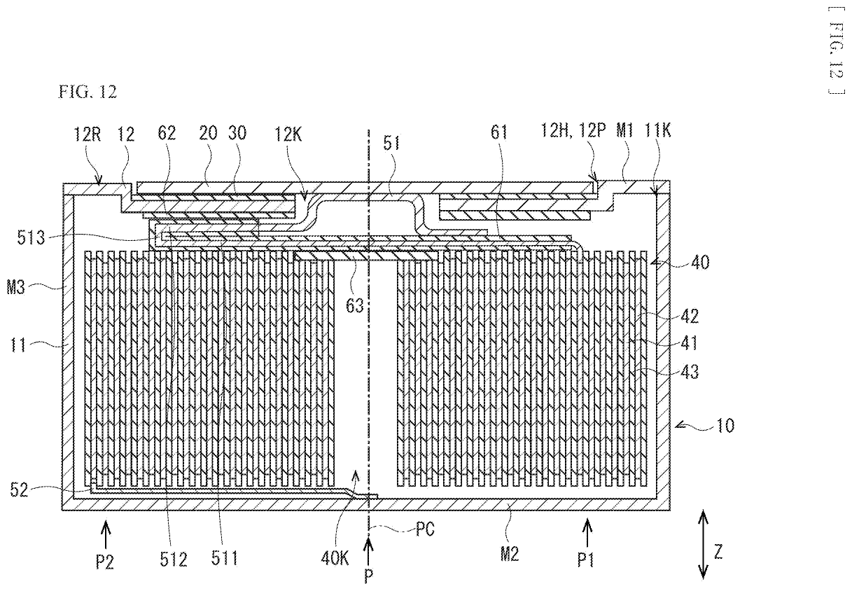

In closing the opening 11K with the cover part 12 after injecting the electrolytic solution into the container part 11 through the opening 11K, the positive electrode lead 51 was shaped to be bent at the turning part 513 (see FIG. 12). FIG. 12 is a sectional diagram illustrating a sectional configuration of the secondary battery of Experiment example 2. Further, the turning part 513 was caused to lie in the space between the protruding part 12P and the battery device 40. Specifically, the distance from the turning part 513 to the inner surface of the sidewall part M3 was adjusted to be 3.0 mm. The secondary battery was obtained that had a configuration otherwise similar to the configuration of Experiment example 1 described above.

### Experiment Example 3

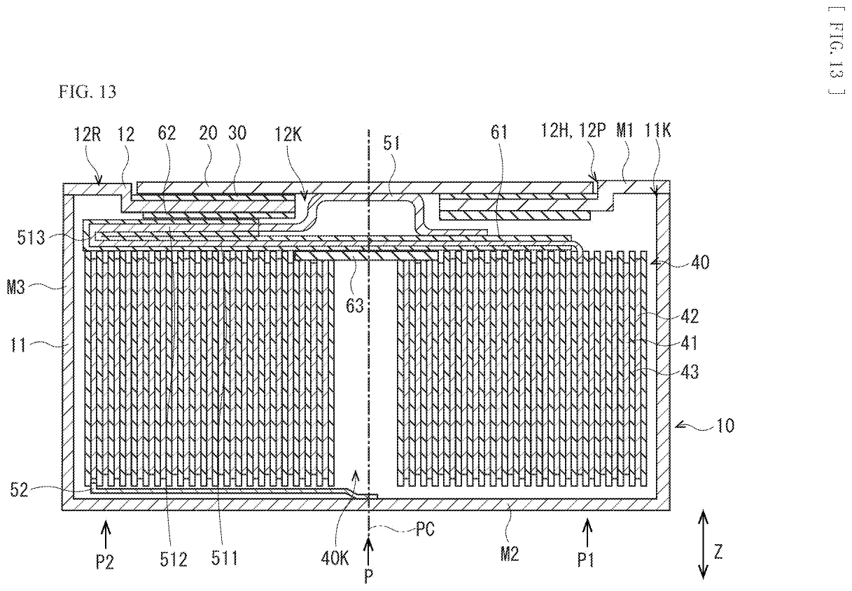

In closing the opening 11K with the cover part 12 after injecting the electrolytic solution into the container part 11 through the opening 11K, the positive electrode lead 51 was shaped to be bent at the turning part 513 (see FIG. 13). FIG. 13 is a sectional diagram illustrating a sectional configuration of the secondary battery of Experiment example 3. The secondary battery was obtained that had a configuration otherwise similar to the configuration of Experiment example 1 described above.

### Experiment Example 4

As illustrated in FIG. 9, the turning part 513 was caused to lie in the space between the protruding part 12P and the battery device 40. Specifically, the distance from the turning part 513 to the inner surface of the sidewall part M3 was adjusted to be 3.0 mm. The secondary battery was obtained that had a configuration otherwise similar to the configuration of Experiment example 1 described above.

### [Evaluation of Performance]

The secondary batteries of Experiment examples 1 to 4 described above were evaluated for physical durability. The evaluation revealed the results presented in Table 1. As the evaluation of physical durability, the secondary batteries were subjected to a vibration test in accordance with the UN Manual of Tests and Criteria to thereby examine whether the positive electrode leads of the secondary batteries were damaged. Here, the number of test secondary batteries was set to 30 for each experiment example. The number of secondary batteries in which the positive electrode leads were broken was entered in the “Number of breakage defects” column of Table 1, and the number of secondary batteries in which the positive electrode leads fell off the external terminal 20 was entered in the “Number of falling-off defects” column of Table 1.

In addition, each secondary battery was subjected to a vibration test to examine the occurrence of a short circuit in the secondary battery. The number of test secondary batteries was set to ten. The results are also presented in Table 1. Conditions for the vibration test were as follows: amplitude was set to 0.8 mm, frequency was set to 10 Hz to 55 Hz, sweep rate was set to 1 Hz/min, and testing time was set to 90 min to 100 min. Further, an open-circuit voltage (OCV) was measured before and after the vibration test. When the open-circuit voltage after the vibration test was 4 V or less, it was determined that the secondary battery had an internal short circuit defect.

TABLE 1

| | Position | Shape of | Vibration test | | Number of |
|---|---|---|---|---|---|
| | of turning | turning | Number of | Number of | internal short |
| | part [mm] | part | breakage defects | falling-off defects | circuit defects |
| Experiment | 0.5 | Curved | 0/30 | 0/30 | 0/10 |
| example 1 | | | | | |
| Experiment | 3.0 | Bent | 1/30 | 1/30 | 2/10 |
| example 2 | | | | | |
| Experiment | 0.5 | Bent | 1/30 | 0/30 | 1/10 |
| example 3 | | | | | |
| Experiment | 3.0 | Curved | 0/30 | 0/30 | 2/10 |
| example 4 | | | | | |

As indicated in Table 1, in each of Experiment examples 2 and 3 in which the turning part of the positive electrode lead had a bent shape, the breakage defect of the positive electrode lead occurred in one out of the 30 secondary batteries. A possible reason for this is that in Experiment examples 2 and 3, due to the positive electrode lead having a bent shape at the turning part, cracks easily developed under vibration, and also the cracks easily expanded.

Further, for Experiment example 2, falling of the positive electrode lead off the external terminal 20 also occurred in one out of the 30 secondary batteries. A possible reason for this is as follows. In Experiment example 2, the turning part of the positive electrode lead was located closer to the center position than in Experiment examples 1 and 3. More specifically, in Experiment example 2, a contact area between the positive electrode lead and the cover part and a contact area between the positive electrode lead and the battery device were smaller than those in Experiment examples 1 and 3, which presumably resulted in failure to sufficiently suppress movements of the positive electrode lead and the battery device inside the outer package can occurring under vibration. Further, for each of Experiment examples 2 to 4, the internal short circuit defect occurred in one or two out of the ten secondary batteries.

In contrast, for Experiment example 1, no damage to the positive electrode lead occurred in any of the 30 secondary batteries, and the numbers of breakage defects and falling-off defects were both zero. For Experiment example 1, no internal short circuit defect occurred, either. In Experiment example 1, owing to the positive electrode lead having a curved shape at the turning part, the positive electrode lead suffered no cracking or other damage even when undergoing vibration, which made it possible to avoid the breakage defect of the positive electrode lead. Moreover, in Experiment example 1, the turning part was disposed at a position corresponding to the peripheral part, which made it possible to sufficiently suppress the movements of the positive electrode lead and the battery device inside the outer package can occurring under vibration. This is presumably because it was possible to ensure a sufficient contact area between the positive electrode lead and the cover part and a sufficient contact area between the positive electrode lead and the battery device.

From the results presented in Table 1, it was confirmed that the secondary battery according to the disclosure achieved higher durability of the positive electrode lead, owing to the positive electrode lead including the turning part having the curved shape. A reason for this is that the turning part having the curved shape helped to prevent a local stress concentration from occurring easily, and thus helped to prevent the positive electrode lead from suffering cracking or breakage easily, as compared with when the turning part had a bent shape. Thus, the secondary battery according to the disclosure was found to make it possible to achieve superior physical durability.

Although the present technology has been described herein with reference to one or more embodiments including Examples, the configuration of the present technology is not limited thereto, and is modifiable in a variety of suitable ways.

For example, although the description has been given of the case where the outer package can is a welded can (a crimpless can), the outer package can is not particularly limited in configuration, and may be a crimped can which has undergone crimping processing. In the crimped can, a container part and a cover part separate from each other are crimped to each other with a gasket interposed therebetween.

Further, although the description has been given of the case where the battery device has a device structure of a wound type, the device structure of the battery device is not particularly limited, and may be of any other type, such as a stacked type in which the electrodes (the positive electrode and the negative electrode) are stacked, or a zigzag folded type in which the electrodes (the positive electrode and the negative electrode) are folded in a zigzag manner.

Further, although the description has been given of the case where the electrode reactant is lithium, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an outer package member;
a battery device placed in the outer package member and including a first electrode and a second electrode;
an external terminal attached to the outer package member and electrically insulated from the outer package member; and
a coupling wiring line electrically insulated from the outer package member and electrically coupled to each of the first electrode and the external terminal, wherein
the coupling wiring line includes a first part, a second part that overlaps with the first part, and a turning part that is curved to allow the first part and the second part to be coupled to each other.

2. The secondary battery according to claim 1, wherein the turning part is curved to define a space inside.

3. The secondary battery according to claim 1, wherein
the outer package member includes a container and a cover part, the container having an opening through which the battery device is placeable, and allowing for placement of the battery device therein through the opening, the cover part closing the opening, and
the coupling wiring line is located between the cover part and the battery device.

4. The secondary battery according to claim 3, wherein
the cover part includes a protruding part protruding toward the battery device,
at least a portion of the first part and at least a portion of the second part are interposed between the protruding part and the battery device in a first direction, and
the turning part is interposed between a portion of the cover part other than the protruding part and the battery device in the first direction.

5. The secondary battery according to claim 4, wherein, in the first direction, the turning part has a thickness greater than a thickness of an overlap portion of the first part and the second part.

6. The secondary battery according to claim 4, wherein, in a plane orthogonal to the first direction, the first part extends from a first position to a second position, the first position being other than a center position of the outer package member, the second position being on a side opposite to the first position as viewed from the center position, and
the second part extends from the second position toward the center position.

7. The secondary battery according to claim 4, wherein
the cover part includes a recessed part formed by the protruding part, and
the external terminal is placed in the recessed part.

8. The secondary battery according to claim 4, wherein
the first part has a first end part on a side opposite to the turning part, the first end part being coupled to the first electrode of the battery device, and
the second part has a second end part on a side opposite to the turning part, the second end part being coupled to a first electrode terminal that is located on a side opposite to the battery device as viewed from the cover part.

9. The secondary battery according to claim 1, further comprising
an insulating member covering a periphery of the coupling wiring line, wherein
a portion of the coupling wiring line is electrically insulated from each of the outer package member and the second electrode by the insulating member.

10. The secondary battery according to claim 1, wherein the outer package member comprises a metal can.

11. The secondary battery according to claim 10, wherein the metal can includes an electrically conductive material including one or more of iron, copper, nickel, stainless steel, an iron alloy, a copper alloy, or a nickel alloy.
